(19) United States
(12) Patent Application Publication
(10) Pub. No.: US 2024/0367219 A1
(43) Pub. Date: Nov. 7, 2024

(54) METHOD FOR THE LAYERED CONSTRUCTION OF MOLDS AND CORES WITH A BINDER CONTAINING WATER GLASS

(71) Applicant: ASK Chemicals GmbH, Hilden (DE)

(72) Inventors: Christian Appelt, Arnsberg (DE); Heinz Deters, Dusseldorf (DE); Dominik Polsakiewicz, Bonn (DE); Katharina Schotten-welter, Wuppertal (DE); Henning Zupan, Haan (DE)

(21) Appl. No.: 18/575,945

(22) PCT Filed: Jun. 21, 2022
(86) PCT No.: PCT/DE2022/100454

§ 371 Date: Jan. 2, 2024

(30) Foreign Application Priority Data
Jun. 30, 2021 (DE) 10 2021 116 930.5

(51) Int. Cl. B22C 1/18; B22C 9/10; B33Y 10/00; B33Y 40/20; B33Y 70/10; B33Y 80/00

(52) U.S. Cl. CPC B22C 1/181; B22C 1/186; B22C 9/10; B33Y 10/00; B33Y 40/20; B33Y 70/10; B33Y 80/00

(57) ABSTRACT

The present invention relates to methods for the layered construction of molds and cores that include refractory molding base material, a hydrophobized metal oxide as solids and a binder containing at least water glass in the form of an aqueous alkali silicate solution. The methods involve applying a refractory molding base material in layers and selectively print the molds and cores using the binder. The present invention further relates to molds or cores produced in accordance with these methods.

### CROSS-REFERENCE TO RELATED APPLICATIONS

This application is a national stage entry of PCT/DE2022/100454, filed Jun. 21,2022.

### FIELD

The invention relates to the layered construction of molds and cores and, more particularly, to the layer construction of molds and cores that include a refractory molding base material, a hydrophobized metal oxide, and a binder that contains at least water glass in the form of an aqueous alkali silicate solution.

### BACKGROUND

Casting molds consist essentially of cores and molds, which represent the negative molds of the casted part, which is to be produced. These cores and molds consist of a fire-resistant material, for example quartz sand, and a suitable binder which provides a sufficient mechanical strength to the casting mold after the removal from the molding tool. To simplify matters, the terms “cores” and “molds” will be jointly referred to below as “casting mold” or “casting molds”. A refractory molding base material, which is provided with a suitable binder, is thus used for the production of casting molds. The refractory molding base material is preferably present in a pourable form so that it can be filled into a suitable hollow mold. Due to the binder, a firm cohesion is created between the particles/grains of the molding base material so that the casting mold obtains the required mechanical stability.

Casting molds have to meet different requirements. During the casting process itself, they have to initially have a sufficient strength and temperature resistance in order to withstand receiving the liquid metal into the hollow space formed by one or several (partial) casting molds. After the beginning of the solidification process, the mechanical stability of the casted part is ensured by means of a solidified metal layer that forms along the walls of the casting mold.

The material of the casting mold has to disintegrate under the influence of the heat emitted by the metal in such a way that it loses its mechanical strength, thus eliminating the cohesion between individual particles/grains of the fire-resistant material. In the ideal case, the casting mold disintegrates into fine sand again which can be easily removed from the casted part.

Various methods for producing three-dimensional bodies by means of layered construction are known under the term “rapid prototyping”. The option of also producing complex bodies, which consist of one piece, with undercuts and hollow spaces is an advantage of these methods. With conventional methods, these bodies would have to be joined together using several individually manufactured parts. A further advantage is that the methods are able to produce the bodies directly from the CAD data without molding tools.

The 3-dimensional printing methods impose new requirements on binders, which hold the casting mold together when the binders or a binder component is applied through the nozzles of a print head. The binder does not only have to lead to a sufficient strength level and to good disintegration properties after the metal casting, as well as having a sufficient thermal and storage stability, but must also be “printable”, i.e., the nozzles of the print head must not accumulate due to the binder and must be able to form individual drops, rather than flowing directly out of the print head in an uncontrollable manner.

It is desirable that, if possible, no emissions in the form of CO₂ or hydrocarbons be created during the production of the casting molds as well as during the casting and cool-down in order to protect the environment and to limit the odor nuisance due to hydrocarbons, mainly due to aromatic hydrocarbons. To meet these requirements, inorganic binding systems have been developed or further developed in recent years, the use of which has resulted in the avoidance or at least a significant minimization in the amount of CO₂ and hydrocarbons emissions during the production of metal casting molds.

EP 1802409 B1 discloses an inorganic binder system, by means of which it is possible to produce casting molds with sufficient stability. This binder system is suitable for thermal curing in a core shooting machine, in which a previously mixed molding material mixture (mixture of at least fire-resistant material and binder) is conveyed into the heated molding tool by means of pressure.

WO 2012/175072 A1 discloses a method for the layered construction of models, in the case of which an inorganic binder system is used. The particulate material, which is applied in layers, comprises a particulate building material and a spray-dried alkali silicate solution. The selective activation of the curing takes place with the help of a solution comprising water, which is added via the print head. Pure water as well as modified water, which contains rheological additives, are disclosed. Thickeners, such as glycerin, glycol, or layer silicates are mentioned in an exemplary manner as rheological additives, whereby the layer silicates in particular are emphasized. WO 2012/175072 A1 does not disclose the use of aqueous alkali silicate solutions. The binder or the water glass solution is not metered via the print head but is already contained in solid form as an alkali silicate in the particulate material, which is applied in layers. According to WO 2012/175072 A1, the selective wetting or setting of a material, which is applied in layers, with the help of a binder can only be accomplished in a roundabout way and not directly with the help of an aqueous alkali silicate solution. Due to the process described in WO 2012/175072 A1, the binder, the spray-dried alkali silicate solution, is not only located at the intended destination, but also in regions in which it is not required. The binder is thus consumed unnecessarily.

DE 102011053205 A1 discloses a method for producing a component part using deposition technique, in the case of which, for example, water glass is used as pressure fluid in addition to many other options. The water glass can therefore be metered by means of a print head and can be applied to a predetermined subregion of the respective uppermost layer. However, DE 102011053205 A1 does not include any information as to which water glass compositions can be used, nor does it prove any information about the physical properties of the used water glasses. Due to this, skilled artisans are limited in their ability to conclusions about chemical compositions of these water glasses. The prior art only mentions inorganic binders (such as, e.g., free-flowing water glass) in very general terms, which usually contains large quantities of moisture—up to 60% by weight of water is specified as example. The large water quantities (e.g. up to 60% by weight of water) are assessed to be disadvantageous because they are difficult to handle.

WO 2013/017134A1 discloses an aqueous alkali silicate solution with a viscosity at 20° C. of 45 mPas or less, which has a solids content with regard to the alkali silicate of 39% by weight. The ratio between SiO₂ and M₂O (M₂O is Na₂O or K₂O) is specified as weight ratio. The narrowest boundaries of this weight ratio lie between 1.58 and 3.30. A method, by means of which it appears to be possible to lower the viscosity of water glass binders with the help of a ball mill, is disclosed in the examples of WO2013/017134A1. However, such a method is highly complex and cost-intensive.

DE 102014118577 A1 describes a method for the layered construction of casting molds comprising refractory molding base material and a binder containing at least an aqueous alkali silicate solution and furthermore a phosphate or a borate or both. However, there is no information as to how a fluid migration of the binder on the substrate could be prevented in order to be able to better maintain the geometric specifications.

DE 102018200607 A1 describes a method for creating casting molds, which are suitable for the production of fiber composite materials or casted parts made of metal or plastic of a particulate molding base material and a multi-component binder by means of 3D printing, whereby the particulate molding base material is pretreated with at least one silicon-organic compound, which has a polar hydrophilic end and a non-polar hydrophobic end. After forming a layer from the pretreated particulate molding base material, the binder or at least one component of the binder is applied to the layer in liquid form. The molding base material and the silicon-organic compound can be part of a set, which is formed to carry out the method. It is the object of DE 102018200607 A1 to minimize the fluid migration of the binder on the substrate in order to be able to better maintain the geometric specifications and to avoid the “running” of the binder in the best possible way. According to the application, it is essential that the set comprises at least one silicon-organic compound, which has a polar hydrophilic end. Liquid components, which have to be mixed with molding base material, are specified as examples for this. This leads to the risk that the building material mixture clumps—in particular, in the case of additional use of fine powder additives (as specified in the application) and thus leads to difficulties in the layered construction. As alternative for the set, it is disclosed that the molding base material could be pretreated with the silicon-organic compound, which has a polar hydrophilic end. The use of such a pretreated molding base material, however, appears to be an expensive matter because the molding base material takes up a very high content of the building material mixture, and the molding base material has to be homogeneously wetted with the silicon-organic compound. In the case of water glass-bound cores, the moisture stability of the produced casting molds has to furthermore be considered. Any organic compounds furthermore lead to undesirable emissions during the metal casting—the use is thus rather undesirable and, if necessary at all, is to be minimized.

### SUMMARY OF THE INVENTION

Disclosed are methods for the 3-dimensional printing of casting molds in which the metering of water glass binders takes place selectively on the spread building material mixture directly via a print head, whereby the spread building material mixture comprises a preferably powdery additive which minimizes the fluid migration of the metered water glass binders and results in a casting mold, which is obtained later and cured, that has extraordinarily good moisture resistance.

In some embodiments, the method for the layered construction of bodies comprises at least the following steps:
a) providing a refractory molding base material as well as a hydrophobized metal oxide as parts of a building material mixture, whereby the hydrophobized metal oxide is hydrophobized with silicon-organic compounds and the content of the hydrophobized metal oxide is 0.0001% by weight to less than 0.4% by weight, based on the refractory molding base material;
b) spreading a thin layer of the building material mixture with a layer thickness of 0.05 mm to 3 mm, preferably 0.1 mm to 2 mm, and particularly preferably 0.1 mm to 1 mm of the building material mixture, whereby the building material mixture comprises the hydrophobized metal oxide;
c) printing selected regions of the thin layer with a binder comprising water glass; and
d) repeated repetition of the steps b) and c).

The body can be a core or a mold (here jointly referred to as casting mold(s)). If the building material mixture is used to produce casting molds, it can also be referred to as molding material mixture.

In some embodiments, the hydrophobized metal oxide is a particulate solid and is present in the building material mixture as particulate solids. The hydrophobized metal oxide can be used as a powder, a suspension (dispersion), or as a gel. The hydrophobized metal oxide is thereby distributed evenly in particulate form in the building material mixture, in particular before the building material mixture is spread out in thin layers. The hydrophobized metal oxide is constructed of a substrate comprising the metal oxide, whereby the surface of the substrate is hydrophobized with silicon-organic compounds.

In some embodiments, when using the hydrophobized metal oxide as part of the building material mixture, the bodies produced therewith may have the following properties:
1. geometric specifications can be maintained very well;
2. good strengths, in particular after thermal curing;
3. very good storage stability;
4. good decomposition properties after the metal casting; and
5. a minimum emission of CO₂ or other organic pyrolysis products during the casting process and cool-down because only a minimum quantity of organic components is used.

Surprisingly, it was found that the hydrophobized metal oxide minimizes the fluid migration of the applied liquid binder as well as significantly increases the moisture resistance of the cured casting mold while hardly negatively influencing the absolute strengths. The emission of organic pyrolysis products is furthermore reduced to a minimum because the hydrophobized metal oxide can be metered in very low quantities.

Clumping or a “dull” building material mixture furthermore does not occur during the layered application of the building material mixture because the good free-flowing ability or pourability of the building material mixture is maintained due to the use of the hydrophobized metal oxide.

### DETAILED DESCRIPTION

The binder according to the invention is provided for the 3-dimensional printing of casting molds. The binder serves as printing liquid, by means of which a material, which is applied in layers, such as, for example, a fire-resistant molding base material (e.g. quartz sand) and optionally one or several additives, jointly referred to as building material mixture, is printed selectively. At the outset, the building material mixture does not yet include the binder. A selective printing process usually takes place in each case after the layered application of the building material mixture. This may occur after the application of one layer, but it is also contemplated that it may occur after the application of two or more layers. This process is repeated until the entire printing process is concluded and the casting mold can be obtained.

The curing of the binder can take place in many ways. For example, one or more water glass hardeners may be added to the building material mixture, which is applied in layers, to affect the direct curing of the printed water glass-containing binder in a chemical way. In another example, the applied water glass may be cured using acidic gasses such as CO₂, but this variation is less preferable.

The binder can also be thermally cured. It is possible, for example, that a thermal curing takes place after the conclusion of one or of each second or third printing process (immediately before, during, or after the next layer of the building material mixture is applied), in that the mixture of building material mixture and binder is irradiated, for example with the help of an infrared light. In this layered curing, the infrared light can be made to track the print head, e.g., in the form of a spot. It is also possible to carry out this type of thermal curing after several applied layers in stages. It is also possible to carry out the thermal curing after ending the last printing process—i.e., the steps “applying a layer of the building material mixture” and subsequent “printing process” alternate until the last layer has been printed, which is required to completely produce the casting mold. For this purpose, the applied and partially printed layers dwell, e.g., in a so-called “job box”, which can subsequently be transferred, e.g., into a microwave oven or into a convection oven to carry out the thermal curing. The thermal curing preferably takes place by means of microwaves and preferably after ending the entire printing process in the microwave oven.

Various materials can be used as refractory molding base materials for the production of casting molds. For example, quartz sand, zircon sand, or chromite sand, olivine, vermiculite, bauxite, chamotte, as well as artificial molding base materials, such as glass beads, glass granulate and/or hollow aluminum silicate microspheres, in particular more than 50% by weight of quartz sand based on the refractory molding base material, is considered suitable. In order to keep costs low, the content of quartz sand in the refractory molding base material is advantageously greater than 70% by weight, preferably greater than 80% by weight, and more preferably greater than 90% by weight.

It is not necessary to use only new sands. In terms of a resource conservation and to avoid landfill costs, it is even advantageous to use the highest possible content of regenerated old sand, as it is available from used molds by means of recycling.

A refractory molding base material is understood to be materials that have a high melting point (melting temperature). The melting point of the refractory molding base material may be greater than 600° C., preferably greater than 900° C., particularly preferably greater than 1200° C., and more preferably greater than 1500° C.

The refractory molding base material may account for greater than 80% by weight, preferably greater than 90% by weight, and particularly preferably greater than 95% by weight, of the building material mixture.

An example of a suitable refractory molding base material, which can be used as part of the building material mixture, is described in WO 2008/101668 A1 (US 2010/173767 A1). Regenerates, which can be obtained by means of washing and subsequent drying of comminuted used molds, may likewise be used in a suitable manner. The regenerates may account for at least approx. 70% by weight of the refractory molding base material, preferably at least approx. 80% by weight, and particularly preferably greater than 90% by weight.

In some embodiments, it may be advantageous for certain applications to use regenerates which have been obtained by means of purely mechanical treatment, meaning that at least a portion of the binder, which remained in the old sand, is removed by means of a grinding or impact principle. These regenerates can be used as needed. The content of these regenerates may be, for example, greater than 5% by weight, preferably greater than 20% by weight, further preferably greater than 50% by weight, particularly preferably greater than 70% by weight, and more preferably greater than 80% by weight of the refractory molding base material. Such regenerates may be used, for example, in order to effect a (pre- or partial) curing of the applied binder.

The average particle size of the refractory molding base material may lie between 50 μm and 600 μm, preferably between 70 μm and 400 μm, preferably between 80 μm and 300 μm, and particularly preferably between 100 μm and 200 μm. The particle size can be determined, e.g., by sieving according to DIN 66165 Part 2. Particulate forms/grains with the largest length expansion to the smallest length expansion (at a right angle to one another and in each case for all spatial directions) from 1:1 to 1:5 or 1:1 to 1:3 are particularly preferred, i.e. those which are not fibrous.

The refractory molding base material may have a pourable state.

Surprisingly, it has now been shown that the hydrophobized metal oxide minimizes the fluid migration of the applied water glass binder as well as significantly increases the moisture resistance of the cured casting mold, whereby the absolute strengths are hardly negatively influenced at the same time. The emission of organic pyrolysis products is furthermore reduced to a minimum because the hydrophobized metal oxide can be metered in very small quantities.

The layered application of the building material mixture furthermore does not lead to clumping or a “dull” building material mixture because the good free-flowing ability or pourability of the building material mixture is maintained due to the use of the hydrophobized metal oxide.

In the case of the hydrophobized metal oxide, the metal oxide is the substrate and the surface of which may be provided with a silicon-organic substance. The hydrophobized metal oxide may be present in particulate form. The metal oxide is preferably amorphous and of synthetic origin.

The metal oxide may be selected from the group of silicon dioxide, aluminum oxide, titanium dioxide, or mixed oxides from this group (e.g. aluminum-silicon mixed oxides). The metal oxide is preferably made of synthetic amorphous silicon dioxide, more preferably, the metal oxide is pyrogenic silica or precipitated silica. The metal oxide may include hydroxy oxides, such as, e.g. boehmite (AlO(OH)) and oxides or hydroxy oxides of metalloids such as silicon.

The following silicon-organic substances can be used to hydrophobize the surface of the metal oxides and thus of the inorganic substrate: silanes, siloxanes, silazanes. The use of C1 to C6 alkyl silazanes, poly(C1 to C6) alkyl siloxanes, and C1 to C6 alkyl silanes are particularly preferred, especially hexamethyldisilazane, polydimethylsiloxanes and chlorine (C1 to C6) alkyl silanes. In one embodiment, the metal oxide, in particular amorphous silicon dioxide, is initially hydrophobized with at least one silicon-organic compound. The hydrophobized metal oxide obtained in this way and the refractory molding base material are combined resulting in the building material mixture, which can comprise other components as well.

The surface modification preferably comprises alkyl siloxy groups, such as C1 to C6 alkyl siloxy groups, and more preferably trimethylsiloxy and dimethylsiloxy groups.

The silicon-organic substances preferably form a covalent bond with the metal oxide, in that OH functionalities of the inorganic substrate are converted with the silicon-organic substance.

In some embodiments, the silicon-organic compound may be devoid of any substituents with a hydrophilic end, in particular in the case of the physisorption. In some embodiments, silicon-organic compounds comprising, as end group, a hydroxy (—OH), ethoxy (—CH₂CH₂—O—), a hydroxylate (—O—), an amino (—NH₂), an ammonium (—NH₄+), a carboxyl (—COOH), or a carboxylate group may be undesirable.

The BET surface according to DIN EN ISO 9277 (nitrogen) of the hydrophobized metal oxide can vary over wide ranges and preferably lies in the range between 2 and 500 m²/g. It has been shown, however, that the specific surface should not be all that high because the mixability with the molding base material is difficult otherwise since the material creates too much dust. The BET surface may be less than 300 m²/g, preferably less than 250 m²/g, and particularly preferably less than 220 m²/g. The BET surface is preferably greater than 5 m²/g, preferably greater than 7 m²/g.

The content of the hydrophobized metal oxide in the building material mixture should be very low, also in order to reduce the emission of organic pyrolysis products to a minimum. The content of the hydrophobized metal oxide, based on the refractory molding base material, is preferably less than 0.2% by weight, and more preferably less than 0.1% by weight, and, on the other hand, greater than 0.001% by weight, and preferably greater than 0.005% by weight.

The drying loss of the hydrophobized metal oxide at the time of use in the building material mixture may be below 10% by weight, preferably below 5% by weight, preferably below 2% by weight, and more preferably below 1% by weight, measured according to DIN EN ISO 787-2 (content of the substances, which are volatile at 105° C., in % by weight).

The carbon content (total) of the hydrophobized metal oxide, determined according to DIN ISO 10694, may be between 0% by weight and 15% by weight, preferably between 0.1% by weight and 8% by weight, particularly preferably between 0.25% by weight and 7% by weight, and most preferably between 0.5% by weight and 6% by weight.

According to a preferred design, the pH value of the hydrophobized metal oxide according to DIN EN ISO 787-9 (measured as 4% by weight dispersion into one part of water and in one part of methanol (volume)) may be between 3 and 11, preferably between 3.5 and 10, and particularly preferably between 4 and 9 at 25° C.

According to a preferred design, the sieve residue (>40 μm) of the hydrophobized metal oxide according to DIN EN ISO 787-18 may be between 0 and 2.5% by weight, preferably between 0 and 1.5% by weight, and particularly preferably between 0 and 1% by weight.

According to one design, the metal oxide content, in particular SiO₂ content of the hydrophobized metal oxide according to DIN EN ISO 3262-19, may lie above 75% by weight, preferably above 80% by weight, particularly preferably above 90% by weight, and most preferably above 95%.

The relative residual silanol (Si—OH) content of the hydrophobized metal oxide describes the remaining OH groups after hydrophobization. It follows from the number of the OH groups of the used hydrophilic silicic acid (with approx. 2 SiOH/nm²), which was processed by means of the above-mentioned hydrophobized metal oxides, and the number of the OH groups of the hydrophobized silicic acid resulting therefrom. Residual silanol contents of 5 to 75% is preferred, particularly preferably 15 to 60%, and most preferably 22 to 55%.

The binder contains water glasses which are produced, for example, by dissolving glass-like lithium, sodium and/or potassium silicates in water. Water glasses which at least contain sodium, the content of which is specified as Na₂O, are preferred.

The ratio Na₂O/M₂O (in each case with M=Na, K, and Li, this also applies below) in the binder may be greater than 0.4, preferably greater than 0.5, and more preferably greater than 0.6, and most preferably greater than 0.7, whereby M₂O stands for the sum of the material quantities of lithium, sodium, and potassium, calculated as oxide in the binder. In a preferred embodiment, the amount of M₂O is equal to Na₂O.

According to one design, the binder may have a molar module SiO₂/M₂O of greater than 1.4, preferably greater than 1.6, preferably greater than 1.8, more preferably greater than 1.9. The water glass preferably may have a molar module of less than 2.8, preferably less than 2.6, preferably less than 2.5, more preferably less than 2.4.

According to one design, the binder may have a solids content of less than 42% by weight, preferably less than 40% by weight, preferably less than 38% by weight, particularly preferably less than 37% by weight. The remaining residue of the binder preferably consists of water.

According to one design, the binder may have a solids content of greater than 20 to less than 42% by weight, preferably greater than 24 to less than 38% by weight, and particularly preferably greater than 27 to less than 37% by weight. The solids content is determined in that the liquid is evaporated off carefully, the binder is thus dried, and is subsequently heated at 600° C. for 1 hour in an air atmosphere. The remaining oxidic material is weighed in order to determine the solids content.

Irrespective of this, the material quantity of SiO₂ and M₂O (calculated as mol %) in the binder may be less than 16 mol %, preferably less than 15 mol %, preferably less than 14 mol %, more preferably less than 13,5 mol %. This material quantity may furthermore be greater than 7 mol %, preferably greater than 8 mol %, preferably greater than 9 mol %, particularly preferably greater than 10 mol %, and more preferably greater than 10.5 mol %.

The binder must not be too fluid, but also not too viscous. The dynamic viscosity is measured using a Brookfield rotational viscometer. According to a preferred design, the binder according to the invention may have a viscosity of less than 20 mPas, preferably less than 18 mPas, preferably less than 16 mPas, and more preferably less than 14 mPas, at a temperature of 25° C. According to one design, also irrespective of this, the binder may have a viscosity of greater than 3 mPas, preferably greater than 5 mPas, preferably greater than 7 mPas, and more preferably greater than 8 mPas, at a temperature of 25° C. The measurement of the viscosity takes place on a Brookfield rotational viscometer with the measurement geometry spindle 18 at a viscosity of up to 16 mPas and a speed of 200 U/min and at a viscosity of below 16 mPas with the measurement geometry spindle UL adapter at a speed of 50 U/min.

According to a preferred design, the density of the binder may be less than 2.5 g/cm³, preferably less than 2.0 g/cm³, and more preferably less than 1.5 g/cm³. According to a preferred design, also irrespective of this, the density may be greater than 1.0 g/cm³, preferably greater than 1.05 g/cm³, and more preferably greater than 1.1 g/cm³. The measurement of the density takes place via the oscillating U-tube method.

According to a preferred design, the surface tension of the binder may be less than 60 mN/m, preferably less than 50 mN/m, and more preferably less than 45 mN/m. According to one design, also irrespective of this, the surface tension of the binder may be greater than 15 mN/m, preferably greater than 20 mN/m, and in particular greater than 25 mN/m. The measurement of the surface tension takes place according to the ring method according to DeNoüy (at 25° C.).

The binder should be a clear solution and should be free from coarser particles, if possible, which, in their largest expansion, have a size between several micrometers to several millimeters and which can originate from contaminations, for example. Commercially available water glass solutions generally have these coarser particles.

The particle sizes in the water glass and also in the binder are determined with the help of dynamic light scattering according to DIN/ISO 13320 (e.g. Horiba LA 950, Fraunhofer method). The determined D₉₀ value (in each case based on the volume) is thereby the measure for the larger particles—it means that 90% of the particles are less than the specified value. The water glass according to the invention may have a D₉₀ value (determined by means of dynamic light scattering) of less than 20 μm, preferably less than 10 μm, and more preferably less than 5 μm.

Irrespective of this, the water glass according to the invention may have, with regard to the solids contained therein, a D₁₀₀ value of less than 25 μm, preferably less than 20 μm, and particularly preferably less than 10 μm.

Above-described water glasses or the binder containing water glasses can be obtained, for example, by means of suitable filtration—filters with a sieve diameter of 25 μm, preferably 10 μm, and particularly preferably 5 μm are suitable, for example. Preferred is a water glass or a binder which contains particles with a maximum size of 1 μm, though it is more preferable that it not contain any particles at all.

In one embodiment, the binder according to the invention can have contents of lithium ions. In such embodiments, the molar ratio of Li₂O/M₂O can vary over wide ranges, for example between 0.01 and 0.3. Preferably, the ratio lies in the range between 0.03 and 0.17, or more preferably between 0.035 and 0.16, and even more preferably between 0.04 and 0.14.

In one embodiment, the binder according to the invention can have contents of potassium ions. In such embodiments, the molar ratio of K₂O/M₂O can vary over wide ranges, for example between 0.01 and 0.3. Preferably, the ratio lies in the range between 0.01 and 0.17, or more preferably between 0.02 and 0.16, and even more preferably between 0.03 and 0.14.

The addition of other network formers such as silicate can increase the thermal stability as well as reduce the reactivity. A phosphate-based network former can be added and dissolved in the binder, in particular alkali phosphates (e.g. sodium hexametaphosphate or sodium polyphosphates) have turned out to be effective.

Among the alkali phosphates, alkali orthophosphates, such as trisodium phosphate (Na₃PO₄) are not preferred. In particular sodium polyphosphates and/or sodium metaphosphates are preferred.

Other network formers, which can alternatively or additionally be added to the binder, are borates, in particular alkali borates, e.g. disodium tetraborate decahydrate. They may also be dissolved in the binder.

The quantities of the alkali metals, which result from the contents of the alkali borates and/or alkali phosphates in the total quantity of the binder (including diluting agent) are calculated as oxides and contribute to the total material quantity (i.e. the sum of the individual material quantities) of lithium, sodium, and potassium oxide in the entire aqueous solution. According to this determination, the molar module SiO₂/M₂O is thus also influenced by adding alkali borates and/or alkali phosphates.

The content of borates in the binder, in particular the content of alkali borates, is calculated as B₂O₃. The molar ratio of B₂O₃/SiO₂ can vary over wide ranges, for example from 0 to 0.5. This ratio may be less than 0.3, preferably less than 0.2, particularly preferably less than 0.1, more preferably less than 0.08, and most preferably less than 0.06. This ratio is preferably greater than or equal to 0. In a further embodiment, this ratio is preferably greater than 0.01, more preferably greater than 0.02. Borates in terms of the invention are boron compounds in the oxidation stage III, which are only bound directly to oxygen, i.e. oxygen atoms are the direct binding partners of the boron in the compound.

The content of phosphates in the binder, in particular the content of alkali phosphates, is calculated as P₂O₅. The molar ratio of P₂O₅/SiO₂ can vary over wide ranges, for example from 0 to 0.5. This ratio may be less than 0.4, preferably less than 0.3, further preferably less than 0.25, more preferably less than 0.2, and most preferably less than 0.15. This ratio is preferably greater than 0, preferably greater than 0.01, more preferably greater than 0.02.

Phosphates in terms of the invention are phosphor compounds in the oxidation stage V, which are only bound directly to oxygen, i.e. oxygen atoms are the direct binding partners of the phosphor in the compound.

In a further embodiment, the binder can also be aluminous, whereby the content of the aluminum is then calculated as Al₂O₃. The content of the Al₂O₃ may be less than 2% by weight, based on the total mass of the binder.

In a preferred embodiment, surface-active substances can be added to the binder in order to influence the surface tension of the binder. The content of these surface-active substances may lie between 0.01 and 4.0% by weight, preferably between 0.1 and 3,0% by weight, based on the total mass of the binder.

Suitable surface-active substances in the binder are described, for example, in DE 102007051850 A1, and preferably include anionic surfactants which carry a sulfate and/or sulfonate group, in particular C8 alkyl sulfates. Further suitable surface-active substances may include, for example, polyacrylate salts (e.g. of sodium—for example Dispex N40—Ciba) or silicon surfactants for aqueous systems (e.g. Byk 348, Altana). Surface-active substances based on trisiloxane or glycol (e.g. polyethylene glycol) may also be used.

In a further embodiment, glycols can be added to the binder in order to make the binder somewhat more “good-natured” or readily capable of being applied. These glycols may include polyethylene glycol, whereby low-molecular polyethylene glycol, such as PEG 200, is particularly preferred. The used polyethylene glycol may have an average molecular weight of less than 1000 g/mol, preferably less than 500 g/mol, and particularly preferably less than 400 g/mol.

The addition of the glycol may lie in the range from 0.01% by weight to 2% by weight, preferably from 0.1% by weight to 1% by weight, and particularly preferably from 0.2% by weight to 0.7% by weight, based on the weight of the binder.

In a further embodiment, alcohols may also be added to the binder in order to make the binder more readily capable of being applied. They may include trivalent alcohols, whereby glycerin is particularly preferred. The addition of the glycol may lie in the range from 0.01% by weight to 2% by weight, preferably from 0.1% by weight to 1% by weight, and particularly preferably from 0.2% by weight to 0.7% by weight, based on the weight of the binder.

Depending on the application and desired strength level, between 0.5% by weight and 7% by weight of the water glass-based binder may be used, preferably between 0.75% by weight and 6% by weight, particularly preferably between 1% by weight and 5.0% by weight, and more preferably between 1% by weight and 4.0% by weight, in each case based on the weight of the molding base material. The specification refers to the total quantity of the water glass binder, including the (in particular aqueous) solvent or diluting agent, respectively, and the (possible) solids content (together=100% by weight).

In a preferred embodiment, the building material mixture may contain a content of a particulate amorphous silicon dioxide in order to increase the strength level of the casting molds. An increase of the strengths of the casting molds, in particular the increase of the heat resistances, can be advantageous in automated manufacturing processes. Synthetically produced amorphous silicon dioxide is particularly preferred.

The average particle size (including possible agglomerates) of the amorphous silicon dioxide may be less than 300 μm, preferably less than 200 μm, and more preferably less than 100 μm. The sieve residue of the particulate amorphous SiO₂ when passing through a sieve with 125 μm mesh size (120 mesh) is preferably not more than 10% by weight, particularly preferably not more than 5% by weight, and most preferably not more than 2% by weight. Irrespective of this, the sieve residue on a sieve with a mesh size of 63 μm may be less than 10% by weight, and preferably less than 8% by weight. The determination of the sieve residue takes place according to the machine sieving method described in the DIN 66165 (Part 2), whereby a chain ring is additionally used as sieving aid.

The particulate amorphous silicon dioxide, which is preferably used according to the present invention, may have a water content of less than 15% by weight, preferably less than 5% by weight, and particularly preferably less than 1% by weight (drying up to a constant mass at 105° C.).

The particulate amorphous SiO₂ used may be a powder (including dusts).

Synthetically produced as well as naturally occurring silicic acids may be used as amorphous SiO₂. Silicic acids are known, e.g., from DE 102007045649, but are not preferred because they generally contain considerable crystalline contents and are thus classified as carcinogenic. The term “synthetic” is understood to be not naturally occurring amorphous SiO₂, i.e. the production of which comprises an intentionally performed chemical reaction, as it is prompted by a person, e.g. the production of silica sols by means of ion exchange processes from alkali silicate solutions, the precipitation from alkali silicate solutions, the flame hydrolysis of silicon tetrachloride, the reduction of quartz sand with coke in the electric arc furnace during the production of ferrosilicon and silicon. The amorphous SiO₂ produced according to the two last-mentioned methods is also referred to as pyrogenic SiO₂.

Synthetic amorphous silicon dioxide is occasionally understood to be precipitated silica (CAS No. 112926-00-8) and SiO₂ produced by means of flame hydrolysis (pyrogenic silica, pyrogenic silica, CAS No. 112945-52-5), while the product created during the ferrosilicon or silicon production, respectively, is referred to as amorphous silicon dioxide (silica fume, micro silica, CAS No. 69012-64-12). For the purposes of the present invention, the product created during the ferrosilicon or silicon production, respectively, is also understood to be amorphous SiO₂.

Precipitated silica and pyrogenic silicon dioxide, i.e. produced by means of flame hydrolysis or in an electric arc, may preferably be used. Amorphous silicon dioxide (described in DE 102012020509) produced by means of thermal decomposition of ZrSiO₄ as well as SiO₂ produced by means of oxidation of metallic Si by means of an oxygenated gas (described in DE 102012020510) may more preferably be used. Quartz glass powder (mainly amorphous silicon dioxide), which was produced by means of melting and quick re-cooling from crystalline quartz, is also preferred, so that the particles are present in spherical and not in splintery form (described in DE 102012020511).

The average primary particle size of the particulate amorphous silicon dioxide may be between 0.05 μm and 10 μm, in particular between 0.1 μm and 5 μm, and particularly preferably between 0.1 μm and 2 μm. The primary particle size can be determined, e.g., using dynamic light scattering (e.g. Horiba LA 950) as well as checked by means of scanning electron microscopy images (REM images, by means of, e.g., Nova NanoSEM 230 by the company FEI). Details of the primary particle form all the way to the magnitude of 0.01 μm could furthermore be made visible with the help of the REM images. For the REM measurements, the silicon dioxide samples were dispersed in distilled water and were subsequently applied to an aluminum holder, to which a copper strip was adhered before the water was evaporated.

The specific surface of the particulate amorphous silicon dioxide may furthermore be determined with the help of gas adsorption measurements (BET method, nitrogen) according to DIN 66131. The specific surface of the particulate amorphous SiO₂ may lie between 1 and 200 m²/g, preferably between 1 and 50 m²/g, and particularly preferably between 1 and 30 m²/g. The products may optionally also be mixed, e.g., in order to systematically obtain mixtures with certain particle size distributions.

Depending on the production type and manufacturer, the purity of the amorphous SiO₂ can vary strongly. Types with a content of at least 85% by weight of silicon dioxide, preferably of at least 90% by weight, and particularly preferably of at least 95% by weight, have turned out to be suitable. Depending on the application and desired strength level, between 0.1% by weight and 2% by weight of the particulate amorphous SiO₂ may used, preferably between 0.1% by weight and 1.8% by weight, particularly preferably between 0.1% by weight and 1.5% by weight, in each case based on the refractory molding base material.

Based on the total weight of the binder (including diluting agent or solvent, respectively), the amorphous SiO₂ may be contained in a content from 1 to 80% by weight, preferably 2 to 60% by weight, particularly preferably from 3 to 55% by weight, and more preferably between 4 to 50% by weight. Or irrespective of this, preferably from 10:1 to 1:1.2 (parts by weight), based on the ratio of solids content of the water glass-based binder (based on the oxides, i.e. total mass of alkali metal oxides M₂O and silicon dioxide) to amorphous SiO₂.

The amorphous SiO₂ is added to the fire-resistant material or to the building material mixture, respectively, prior to the binder addition. When using amorphous SiO₂, the method according to the invention is thus furthermore characterized by one or more of the following features:
a) the amorphous silicon dioxide is only added to the building material mixture;
b) the amorphous silicon dioxide has a surface, which is determined according to BET, between 1 and 200 m²/g, preferably greater than or equal to 1 m²/g and less than or equal to 30 m²/g, particularly preferably of less than or equal to 15 m²/g;
c) the amorphous silicon dioxide is selected from the group consisting of: precipitated silica, pyrogenic silicon dioxide produced by means of flame hydrolysis or in the electric arc, amorphous silicon dioxide produced by means of thermal decomposition of ZrSiO₄, silicon dioxide produced by means of oxidation of metallic silicon by means of an oxygenated gas, quartz glass powder with spherical particles, which was produced by means of melting and quick re-cooling from crystalline quartz, and the mixtures thereof, and is amorphous silicon dioxide, which is preferably produced by means of thermal decomposition of ZrSiO₄;
d) the amorphous silicon dioxide is preferably used in quantities from 0.1 to 2% by weight, particularly preferably 0.1 to 1.5% by weight, in each case based on the refractory molding base material;
e) the amorphous silicon dioxide has a water content of less than 5% by weight and particularly preferably of less than 1% by weight; and
f) the amorphous silicon dioxide is particulate amorphous silicon dioxide, and may have an average primary particle diameter between 0.05 μm and 10 μm, preferably between 0.1 μm and 5 μm, and particularly preferably between 0.1 μm and 2 μm, which is determined by means of dynamic light scattering.

In a further embodiment, an inorganic hardener for binders on the basis of water glass is optionally added to the building material mixture prior to the binder addition. Such inorganic hardeners may include phosphates, such as, for example, Lithopix P26 (an aluminum phosphate by the company Zschimmer und Schwarz GmbH & Co KG Chemische Fabriken) or Fabutit 748 (an aluminum phosphate by the company Chemische Fabrik Budenheim KG). Other inorganic hardeners for binders on the basis of water glass may include, for example, calcium silicates and the hydrates thereof, calcium aluminates and the hydrates thereof, aluminum sulfate, magnesium and calcium carbonate.

The ratio of hardener to binder can vary depending on the desired properties, e.g. processing time and/or stripping time of the building material mixtures. The hardener content (weight ratio of hardener to binder and in the case of water glass, the total mass of the silicate solution or other binders received in solvents) is advantageously greater than or equal to 5% by weight, preferably greater than or equal to 8% by weight, and more preferably greater than or equal to 10% by weight, in each case based on the binder. The upper limits may be less than or equal to 25% by weight, based on the binder, preferably less than or equal to 20% by weight, particularly preferably less than or equal to 15% by weight.

Irrespective of this, between 0.05% by weight and 2% by weight of the inorganic hardener may be used, preferably between 0.1% by weight and 1% by weight, particularly preferably between 0.1% by weight and 0.6% by weight, in each case based on the molding base material.

As soon as the strengths allow for it, the unbound building material mixture can subsequently be removed from the casting mold and the casting mold can be supplied for further treatment, e.g. the preparation for the metal casting. The removal of the unbound from the bound building material mixture can be accomplished, for example, by means of an outlet so that the unbound building material mixture can trickle out. The bound building material mixture (casting mold) can be freed from the residues of the unbound building material mixture, for example with the help of compressed air or by means of brushes.

The unbound building material mixture may be reused for a new printing process.

The printing may takes place by means of a print head having a plurality of nozzles, whereby the nozzles can preferably be selectively controlled individually. According to a further design, the print head is moved at least in one plane, controlled by a computer, and the nozzles apply the liquid binder in layers. The print head can be, e.g., a drop-on-demand print head with bubble jet or preferably piezo technology.

### EXAMPLES

The invention is described below on the basis of experiment examples, but not meant to be limited to them. Unless other information is provided, all ratios and percentages refer to the weight.

### Example 1: Analysis of the Dimensional Accuracy

In order to assess the dimensional accuracy of components when constructing three-dimensional bodies, a molding base material mixture consisting of sand GS 14 (average grain diameter 0.14 mm) with additional 0.8% by weight of a powdery additive (amorphous SiO₂) (molding base material mixture 1) was homogenized in a rotary blade mixer. Additives were further added to the molding material mixture 1 in order to produce the molding material mixtures 2 to 6. The following molding material mixtures were produced in a rotary blade mixer in this way:
Molding material mixture 2: molding material mixture 1+0.05% by weight of additive 1 (HDK H 30 by the company Wacker, dimethylsiloxy-substituted on the surface);
Molding material mixture 3: molding material mixture 1+0.1% by weight of additive 2 (HDK H 13 L by the company Wacker, dimethylsiloxy-substituted on the surface);
Molding material mixture 4: molding material mixture 1+0.05% by weight of additive 3 (HDK H 2000 by the company Wacker, trimethylsiloxy-substituted on the surface);
Molding material mixture 5: molding material mixture 1+0.02% by weight of additive 4 (surface covered with silicon oil AP 100 by the company Wacker, comparison);
Molding material mixture 6: molding material mixture 1+0.02% by weight of additive 5 (surface coverage with polyether-modified trisiloxane according to DE 102018200607 A1, comparison); and
Molding material mixture 7: molding material mixture 1+0.1% by weight of additive 6 (SIPERNAT D10/1 by the company EVONIK, polydimethylsiloxy-substituted on the surface)

The production of the sample bodies took place on a commercial printing system (VX 200 by the company Voxeljet AG). An alkaline solution (water glass with a viscosity of approximately 11 mPas at 25° C., molar module SiO₂/M₂O of 2.0, solids content of 29% by weight, by the company ASK Chemicals GmbH) was used as binder in the printing process. The quantity of binder was fixed in all tests at 3.5 parts by weight, based on 100 parts by weight of molding base material mixture. Bending bolts with the dimensions (22.36 mm×22.36 mm×170.00 mm) were produced as sample bodies. After the printing, the sample bodies were cured in a microwave for 4.5 min at a power of 1000 Watt.

To assess the dimensional accuracy, the width and the height of the produced bending bolts were measured and compared with the original dimensions of the print file. The evaluation took place via the averaging of 6 sample bodies for each molding material mixture. The dimensional deviations in width and height for each molding material mixture are described in Table 1.

TABLE 1
Dimensional deviations of different molding material
mixtures with 3.5% of binder INOTEC EP 5061 after
curing in the microwave (V = comparison)

| | Average | Average |
|---|---|---|
| | deviation in | deviation in |
| | the width | the height |
| Molding material mixture | [mm] | [mm] |
| Molding material mixture 1 (V) | 1.34 | 1.36 |
| Molding material mixture 2 | 0.69 | 0.78 |
| Molding material mixture 3 | 0.44 | 0.43 |
| Molding material mixture 4 | 0.37 | 0.28 |
| Molding material mixture 5 (V) | N/A | N/A |
| Molding material mixture 6 (V) | 0.23 | 0.20 |
| Molding material mixture 7 | 0.18 | 0.06 |

No values could be recorded with regard to the dimensional deviation for molding material mixture 5. During the processing on the printing system, no sample bodies could be obtained because an insufficient layer composite of the individual layers prevented the production of sample bodies. The tests show that significantly lower dimensional deviations of the sample bodies result with the use of the additives according to the invention. The fluid migration in the printing process is thus significantly reduced by means of the additives according to the invention, which provides for the production of components with high dimensional accuracy.

### Example 2: Analysis of the Moisture Stability

In a further test series, bending bolts were produced in the same way as in Example 1. The strength was determined 1 hour after the production, 24 hours after storage under ambient conditions, and 24 hours after storage at a controlled climate of 30° C. and 49% of relative moisture on two bending locks for each analyzed molding material mixture (molding material mixtures 1 to 4 as well as 6 and 7). The obtained strengths are described in Table 2.

TABLE 2
Strengths of different molding material mixtures with
3.5% binder INOTEC EP 5061 after curing in the microwave
after 1 h, 24 h under ambient conditions and 24 h at
30° C. and 49% of relative moisture (V = comparison)

| | | | Strength after |
|---|---|---|---|
| | Strength | Strength after | 24 h storage at |
| | 1 h after | 24 h storage at | 30° C. and 49% of |
| Molding material | production | ambient conditions | relative moisture |
| mixture | [N/cm²] | [N/cm²] | [N/cm²] |
| Molding material | 422 | 409 | 285 (−33%) |
| mixture 1 (V) | | | |
| Molding material | 407 | 424 | 380 (−7%) |
| mixture 2 | | | |
| Molding material | 377 | 395 | 358 (−5%) |
| mixture 3 | | | |
| Molding material | 392 | 394 | 370 (−6%) |
| mixture 4 | | | |
| Molding material | N/A | N/A | N/A |
| mixture 5 (V) | | | |
| Molding material | 425 | 408 | 336 (−21%) |
| mixture 6 (V) | | | |
| Molding material | 431 | 420 | 366-15%) |
| mixture 7 | | | |

Molding material mixture 1 shows a weak drop of the strength at storage under ambient conditions, but a drastic decline of the strength in the case of storage at 30° C. and 49% of relative moisture.

In the case of a similar start strength, the molding material mixture 2 according to the invention has a significantly higher strength after storage at 30° C. and 49% of relative moisture. The molding material mixtures 2 to 4 according to the invention behaved similarly, albeit with slightly reduced start strengths. Analogously to the determination of the dimensional accuracy, no strengths could be determined for molding material mixture 5. The reason for this is an insufficient layer composite during the production of the samples on the commercial printing system VX 200. Molding material mixture 6 shows high strengths 1 hour after sample preparation, but a stronger relative strength drop compared to molding material mixtures 2 to 4 in the case of storage under stricter climate conditions (79% remaining strength for molding material mixture 6, on average 94% for the molding material mixtures 2 to 4 according to the invention). Molding material mixture 7 had high strengths after 1 hour and a moderate drop of the strengths after storage at 30° C. and 49% of relative moisture for 24 hours.

Due to the use of the additives according to the invention, a significantly improved storage stability, in particular under stricter climate conditions, can thus be obtained as compared to a formulation without them or a formulation according to DE 102018200607 A1. Storage of produced components even under stricter external conditions is made possible through this, without having to accept the currently occurring strength losses. In addition, the molding material mixtures 2 to 4 according to the present invention with an organic carbon content (without graphite) of maximally 0.00015% (addition of up to 0.1% with a maximum carbon content of 15%) have a very low emission potential, in particular compared to molding material mixture 6 which is in accordance with DE 102018200607 A1 with a carbon content of 0.01% (addition to the molding material mixture starting at 0.01% with a carbon content of 100%). This provides a drastic reduction of the emission burden when using the molding material mixtures according to the present invention

Any embodiment of the present invention may include any of the features of the other embodiments of the present invention. The exemplary embodiments herein disclosed are not intended to be exhaustive or to unnecessarily limit the scope of the invention. The exemplary embodiments were chosen and described in order to explain the principles of the present invention so that others skilled in the art may practice the invention. Having shown and described exemplary embodiments of the present invention, those skilled in the art will realize that many variations and modifications may be made to the described invention. Many of those variations and modifications will provide the same result and fall within the spirit of the claimed invention. It is the intention, therefore, to limit the invention only as indicated by the scope of the claims.

1. A method for the layered construction of bodies comprising at least the following steps:
a) providing a refractory molding base material as well as a hydrophobized metal oxide as components of a building material mixture, wherein the hydrophobized metal oxide is hydrophobized with silicon-organic compounds and the content of the hydrophobized metal oxide is 0.0001% by weight to less than 0.4% by weight, based on the refractory molding base material;
b) spreading a thin layer of the building material mixture with a layer thickness of 0.05 mm to 3 mm, preferably 0.1 mm to 2 mm, and particularly preferably 0.1 mm to 1 mm of the building material mixture, wherein the building material mixture comprises the hydrophobized metal oxide;
c) printing selected regions of the thin layer with a binder comprising water glass, and
d) multiple repetitions of the steps b) and c).

2. The method according to claim 1, wherein the hydrophobized metal oxide is constructed of a substrate comprising the metal oxide, wherein the surface of the substrate is hydrophobized with the silicon-organic compound.

3. The method according to claim 1 or 2, wherein the metal oxide of the hydrophobized metal oxide is selected from the group of silicon dioxide, aluminum oxide, titanium dioxide, or mixed oxides from this group, and in particular is or comprises amorphous silicon dioxide.

4. The method according to at least any one of the preceding claims, wherein the silicon-organic compound chemically converts with OH groups on the surface of the metal oxide.

5. The method according to at least any one of the preceding claims, wherein the silicon-organic compound is selected from silanes, siloxanes, silazanes, in particular C1 to C6 alkyl silazanes, C1 to C6 alkyl silanes, and further preferably is hexamethyldisilazane or a chlorine (C1 to C6) alkyl silane.

6. The method according to at least any one of the preceding claims, wherein the hydrophobized metal oxide comprises C1 to C6 alkyl siloxy groups, more preferably trimethyl siloxy and/or dimethyl siloxy groups on the surface.

7. The method according to at least any one of the preceding claims, wherein the silicon-organic compound does not have any substituents with a hydrophilic end.

8. The method according to at least any one of the preceding claims, wherein the hydrophobized metal oxide is added to the building material mixture as powder, suspension, or as gel, in particular powder, before the building material mixture is spread out in layers.

9. The method according to at least any one of the preceding claims, wherein the metal oxide or the substrate, respectively, of the hydrophobized metal oxide comprises or consists of synthetic amorphous silicon dioxide, in particular comprises or consists of pyrogenic silica or precipitated silica.

10. The method according to at least any one of the preceding claims, wherein the hydrophobized metal oxide is characterized by one or several of the following features:
a) it has a BET surface from 2 to 500 m²/g, preferably from greater than 5 m²/g to less than 300 m²/g, and particularly preferably from greater than 7 m²/g to less than 220 m²/g;
b) the carbon content of the hydrophobized metal oxide is greater than 0% by weight to 15% by weight, preferably 0.1% by weight to 8% by weight, particularly preferably 0.25% by weight to 7% by weight, and most preferably 0.5% by weight to 6% by weight;
c) the pH value of the hydrophobized metal oxide is 3 to 11, preferably 3.5 to 10, and particularly preferably 4 to 9;
d) the metal oxide content, in particular the SiO₂ content, of the hydrophobized metal oxide is above 75% by weight, preferably above 80% by weight, particularly preferably above 90% by weight, and most preferably above 95% by weight;
e) the relative residual silanol (Si—OH) content of the hydrophobized metal oxide is from 5 to 75%, particularly preferably 15 to 60%, and most preferably 22 to 55%.

11. The method according to at least any one of the preceding claims, wherein the hydrophobized metal oxide, based on the refractory molding base material is used at greater than 0.001% by weight to less than 0.2% by weight, and more preferably greater than 0.005% by weight to less than 0.1% by weight.

12. The method according to at least any one of the preceding claims, furthermore comprising the step of the curing of the printed regions, in particular by means of temperature increase, preferably caused by microwaves and/or infrared light.

13. The method according to at least any one of the preceding claims, furthermore comprising the following steps:
i) curing the body after ending the layered construction in an oven or by means of microwave, and
ii) subsequent removal of the unbound building material mixture from the at least partially cured printed selected regions.

14. The method according to at least any one of the preceding claims, wherein, in each case also independently of one another:
a) the refractory molding base material comprises quartz sand, zircon sand, or chromite sand, olivine, vermiculite, bauxite, chamotte, glass beads, glass granulate, hollow aluminum silicate microspheres and the mixtures thereof, and preferably more than 50% by weight thereof consists of quartz sand based on the refractory molding base material; and/or
b) the building material mixture comprises greater than 80% by weight, preferably greater than 90% by weight, and particularly preferably greater than 95% by weight, of refractory molding base material; and/or
c) the refractory molding base material has an average particle size from 50 μm to 600 μm, preferably between 80 μm and 300 μm, determined by means of sieve analysis.

15. The method according to at least any one of the preceding claims, wherein the water glass, including solvent/diluent is applied in a quantity between 0.5% by weight and 7% by weight, preferably between 0.75% by weight and 6% by weight, and particularly preferably between 1% by weight and 5.0% by weight, based on the molding base material.

16. The method according to at least any one of the preceding claims, wherein the printing takes place by means of a print head having a plurality of nozzles; wherein
a) the print head is preferably moveable at least in one plane, controlled by a computer, and the nozzles apply the liquid binder in layers; and/or
b) the print head is preferably a drop-on-demand print head with bubble jet or piezo technology.

17. The method according to at least any one of the preceding claims, wherein the building material mixture furthermore contains particulate amorphous silicon dioxide, preferably between 0.1% by weight and 2% by weight, and particularly preferably between 0.1% by weight and 1.5% by weight, in each case based on the refractory molding base material and preferably with a particle size of less than 300 μm, preferably less than 200 μm, more preferably less than 100 μm.

18. The method according to at least any one of the preceding claims, wherein the binder is characterized by one or several of the following features:
the water glass has a molar module SiO₂/M₂O of greater than 1.4 to less than 2.8, preferably greater than 1.6 to less than 2.6, preferably greater than 1.8 to less than 2.5, and further preferably greater than 1.9 and less than 2.4, wherein M₂O stands for the sum of the molar material quantities of lithium, sodium, and potassium, in each case calculated as oxide;
at a temperature of 25° C. in each case, the binder has a dynamic viscosity of less than 20 mPas, preferably less than 14 mPas;
possible particulate components in the binder have a De value of less than 20 μm, preferably less than 10 μm, and more preferably less than 5 μm;
the binder contains at least one phosphate or at least one borate or a phosphate and a borate.

19. The method according to at least any one of the preceding claims, wherein the binder has a solids content of greater than 20 to less than 42% by weight, preferably greater than 24 to less than 38% by weight, preferably greater than 27 to less than 37% by weight.

20. The method according to at least any one of the preceding claims, wherein any particles in the binder
have a D₉₀ value of less than 20 μm, preferably less than 10 μm, particularly preferably less than 5 μm, and/or
have a D₁₀₀ value of less than 25 μm, preferably less than 15 μm, preferably less than 10 μm.

21. The method according to at least any one of the preceding claims, wherein the binder furthermore contains surface-active substances, preferably surfactants, in particular between 0.01 and 4.0% by weight, preferably between 0.1 and 3.0% by weight.

22. A mold or core, obtainable according to at least any one of claims 1 to 21 for the metal casting, in particular the iron, steel, copper, or aluminum casting.
